(19) United States
(12) Patent Application Publication
(10) Pub. No.: US 2020/0380507 A1
(43) Pub. Date: Dec. 3, 2020

(54) VIRTUAL FINANCIAL CONTINUITY VIA AN AI-BASED SIMULACRUM

(71) Applicant: Wells Fargo Bank, N.A., San Francisco, CA (US)

(72) Inventor: Chris Kalaboukis, San Jose, CA (US)

(21) Appl. No.: 15/492,149

(22) Filed: Apr. 20, 2017

(51) Int. Cl. G06Q 20/40; G06Q 20/32; G06Q 10/10; G06F 19/00

(52) U.S. Cl. CPC G06Q 20/40; G06F 19/3418; G06Q 10/109; G06Q 20/3224

(57) ABSTRACT

In one or more embodiments, a method, system and computer program product provide automating performance of a pattern of financial transactions by analyzing a pattern of financial transactions performed by a human operator. A predictive model is developed for a response by the human operator to a future financial transaction opportunity based on the analyzed pattern of financial transactions. At least one of: (i) a sensor in proximity to the human operator and (ii) a communication channel used by the human operator is monitored to detect a triggering event. The triggering event indicates authorization for an automated response in lieu of the response by the human operator to the future financial transaction opportunity. The automated response is performed to complete the future financial transaction in response to the triggering event.

### BACKGROUND

The present application relates to systems and methods for automating execution of financial transactions on behalf of a human operator.

Individuals and other entities often rely on computer-based systems for different types of financial transactions, including paying bills, transferring funds into investment accounts, tracking budgeted expenditures, and so on. Individuals who handle such transactions can also have a number of manual transactions that are performed via the mail or in person. Handling the varied transactions can be complicated even with technical assistance due to the many ways the transactions are initiated, authenticated, and tracked. Individuals may be unwilling or unavailable to complete financial transactions. The results of falling behind on recurring transactions can be added penalties, loss of services, and adverse legal consequences.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

One or more embodiments of techniques or systems for virtual transaction continuity are provided herein. Generally, an artificial intelligence (AI) based simulacrum learns how a customer or human operator performs financial transactions. When the human operator is voluntarily or involuntarily unavailable or incapacitated, the simulacrum can act as an agent to complete the financial transactions in a manner that is similar to the human operator.

In one or more embodiments, the present disclosure provides a method for automating performance of a pattern of financial transactions. The method includes analyzing a pattern of financial transactions performed by a human operator. The method includes developing a predictive model for a response by the human operator to a future financial transaction opportunity based on the analyzed pattern of financial transactions. The method includes monitoring at least one of: (i) a sensor in proximity to the human operator and (ii) a communication channel used by the human operator to detect a triggering event. The triggering event indicates authorization for an automated response in lieu of the response by the human operator to the future financial transaction opportunity. The method includes performing the automated response to complete the future financial transaction in response to the triggering event.

In one or more embodiments, the present disclosure provides a system comprising a transaction analyzing component that analyzes a pattern of financial transactions performed by a human operator. A simulacrum engine develops a predictive model for a response by the human operator to a future financial transaction opportunity based on the analyzed pattern of financial transactions by the transaction analyzing component. A communication component monitors at least one of: (i) a sensor in proximity to the human operator and (ii) a communication channel used by the human operator to detect a triggering event. The trigger event indicates authorization for an automated response in lieu of the response by the human operator to the future financial transaction opportunity. A simulacrum avatar performs the automated response to complete the future financial transaction in response to the triggering event.

In one or more embodiments, the present disclosure provides a computer-readable storage medium comprising computer-executable instructions, which when executed via a processing unit on a computer performs acts. The acts include analyzing a pattern of financial transactions performed by a human operator. The acts include developing a predictive model for a response by the human operator to a future financial transaction opportunity based on the analyzed pattern of financial transactions. The acts include monitoring at least one of: (i) a sensor in proximity to the human operator and (ii) a communication channel used by the human operator to detect a triggering event. The triggering event indicates authorization for an automated response in lieu of the response by the human operator to the future financial transaction opportunity. The acts include performing the automated response to complete the future financial transaction in response to the triggering event.

The following description and annexed drawings set forth certain illustrative aspects and implementations. These are indicative of but a few of the various ways in which one or more aspects may be employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 illustrates a block diagram of a system for virtual financial continuity, according to one or more embodiments;

FIG. 2 illustrates a block diagram of a communication system for virtual financial continuity, according to one or more embodiments;

FIG. 3 illustrates a block diagram of a system having a computing device that performs virtual financial continuity, according to one or more embodiments;

FIG. 4 illustrates a block diagram of example computer-readable medium or computer-readable device including processor-executable instructions configured to embody one or more of the provisions set forth herein, according to one or more embodiments.

FIG. 5 illustrates a depiction of a user interface on a user device, according to one or more embodiments;

FIG. 6 illustrates a flow diagram of a method of virtual financial continuity, according to one or more embodiments; and

FIG. 7 illustrates a flow diagram of a method of detecting incapacity of the human operator, according to one or more embodiments.

### DETAILED DESCRIPTION

The present disclosure provides an artificial intelligence (AI) simulacrum of an individual's financial actions that can assist an individual. In certain instances, the AI simulacrum can continue to perform their financial actions when temporarily or permanently unavailable to complete the transactions. In one or more embodiments, a method, system and computer program product provide automating performance of a pattern of financial transactions by analyzing a pattern of financial transactions performed by a human operator. A predictive model is developed for a response by the human operator to a future financial transaction opportunity based on the analyzed pattern of financial transactions. At least one of: (i) a sensor in proximity to the human operator and (ii) a communication channel used by the human operator is monitored to detect a triggering event. The triggering event indicates authorization for an automated response in lieu of the response by the human operator to the future financial transaction opportunity. The automated response is performed to complete the future financial transaction in response to the triggering event.

In many relationships, there is one individual who handles most to all of the financial tasks. Unfortunately, if this individual then becomes incapacitated or passes way, all of the financial tasks which that individual completes then lapse, as their partner may have no knowledge of the financial tasks which are required to be completed. This can also occur if a customer wishes to travel and/or be unavailable to make the financial decisions. Even not incapacitated, the individual handling the financial tasks may welcome automating this task as a convenience and safeguard against missing an important transaction.

The present innovation provides a system that tracks a customer's financial actions over time, and, by using a plurality of inputs, including but not limited to: (i) bill payments; (ii) transfers; (iii) payments; (iv) charges; (v) social media posts; and (vi) email. The system creates an AI-based simulacrum or intelligent agent (or number of agents), who can then continue to complete the actions of the customer, if they become incapacitated or deceased. This simulacrum uses machine learning to capture and understand a customer's financial patterns, predictive analytics, among other methodologies, to determine a customer's future financial activity, and continue that customers activity, should they, for any reason, be unable to complete that activity.

The simulacrum is created and improved over time, and can be triggered into action by the customer they are patterning, by the caregiver of the customer or by detecting that the customer is no longer completing the typical financial actions that they normally complete. To expedite the process, historical transactions can be batch analyzed.

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

The following terms are used throughout the disclosure, the definitions of which are provided herein to assist in understanding one or more aspects of the disclosure.

As used herein, the term “infer” or “inference” generally refer to the process of reasoning about or inferring states of a system, a component, an environment, a user from one or more observations captured via events or data, etc. Inference may be employed to identify a context or an action or may be employed to generate a probability distribution over states, for example. An inference may be probabilistic. For example, computation of a probability distribution over states of interest based on a consideration of data or events. Inference may also refer to techniques employed for composing higher-level events from a set of events or data. Such inference may result in the construction of new events or new actions from a set of observed events or stored event data, whether or not the events are correlated in close temporal proximity, and whether the events and data come from one or several event and data sources.

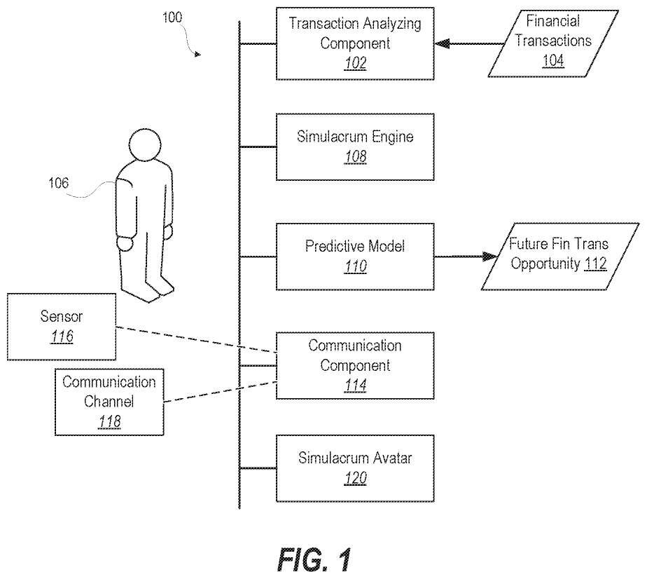

Turning to the Drawings, FIG. 1 illustrates a system 100 having a transaction analyzing component 102 that analyzes a pattern of financial transactions 104 performed by a human operator 106. A simulacrum engine 108 develops a predictive model 110 based on the pattern of financial transactions 104. The predictive model 110 can be accessed used to predict a response by the human operator 106 to a future financial transaction opportunity 112. The prediction can be based on the analyzed pattern of financial transactions by the transaction analyzing component 102. A communication component 114 monitors at least one of: (i) a sensor 116 in proximity to the human operator 106 and (ii) a communication channel 118 used by the human operator 106. The monitoring provides a basis for detecting a triggering event indicating authorization for an automated response in lieu of the response by the human operator 106 to the future financial transaction opportunity. A simulacrum avatar 120 performs the automated response to complete the future financial transaction in response to the triggering event. The simulacrum avatar 120 thus enabled by the predictive model 110 and created using AI-based methodologies provides virtual financial continuity.

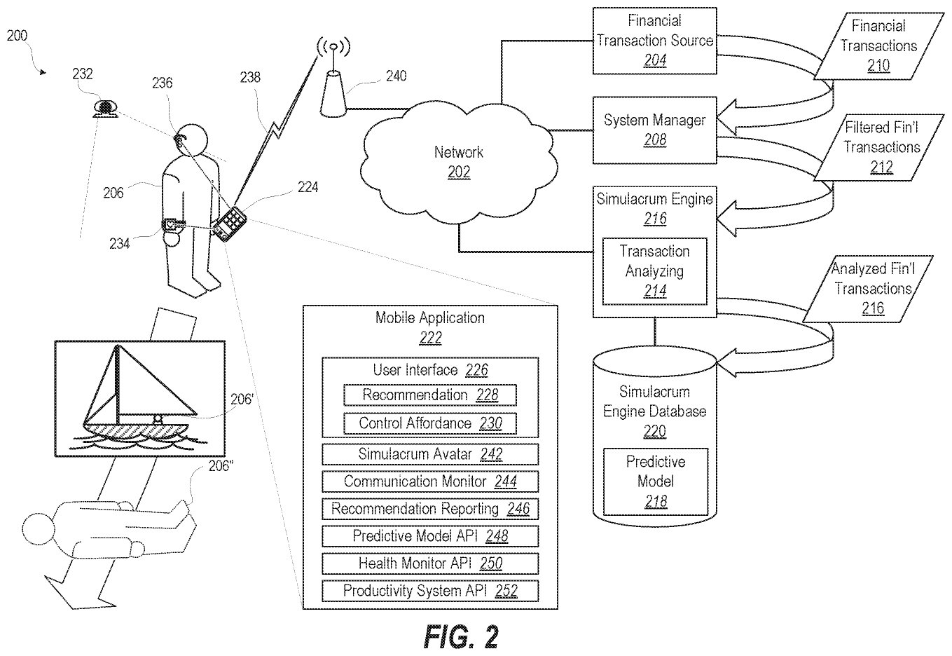

In one or more embodiments, FIG. 2 illustrates a communication system 200 having a network 202 that couples sources of data and processing capabilities to perform virtual financial continuity. One or more financial transaction sources 204 provide past or current financial transactions, either open for completion by a human operator 206 or previously completed. A system manager 208 can obtain relevant financial transactions 210 from the financial transactions sources 204 and provide filtered financial transactions 212 to the transaction analyzing component 214 of a simulacrum engine 216. The simulacrum engine 216 can create and maintain a predictive model 218 for the human operator 206 that is contained in a simulacrum engine database 220. Mobile application 222 executed on a user device 224 can provide a user interface 226 for providing recommendations 228 for and for receiving activation of control affordances 230 from the human operator 206. The user device 224 itself can contain sensors and communication channels that enable monitoring of a capacity status of the human operator 206. For clarity, external sources of information regarding the health, location, activity level, cognitive interactions, etc., by the human operator 206 are illustrated as a camera 232, a smart watch 234, and a blue tooth device 236, or other Internet of Things (IoT) devices. Thus, an ability is provided to capture health and mobility levels of the human operator. This ability could leverage other devices used to monitor an individual's health in general (e.g., activity trackers, heart rate monitors). The mobile application 222 can communicate via a communication channel 238 to a node 240 that in turn is communicatively coupled to the network 202.

Portions of the processing of the virtual financial continuity capability can be executed by the mobile application 222, such as a simulacrum avatar 242, a communication monitor 244, and recommendation reporting 246. In one or more embodiments, all of the processing can occur on a single device. For portions of the virtual financial continuity capability that are remote to the mobile application 222, the mobile application 222 can contain application program interfaces (APIs) that handle interchanges of control and data information. For example, the mobile application 222 can include a predictive model API 248, a health monitor API 250, and a productivity system API 252 for integrating with office automation systems.

By monitoring the human operator 206, the mobile application 222 can determine whether the human operator 206 is active and capable of completing financial transactions. In such event, the mobile application 222 may determine triggering events such as financial transactions opportunities that the human operator 206 has pre-authorized for automatic execution, approves automatic execution in an ad hoc manner, or has acquiesced to automated execution by failing to act in a timely fashion. Future financial transactional opportunities can be characterized for semi-autonomous handling due to whether the predictive model and authorizations enable automatic execution or not.

By monitoring the human operator 206, the mobile application 222 can also determine that the human operator 206′ has reduced availability, such as being out of communication during a vacation. More future financial transactional opportunities can become overdue during this period prompting increased automatic execution. By monitoring the human operator 206″, the mobile application 222 may also determine that the human operator 206″ is either temporarily or permanently incapacitated such the human operator 206″ cannot physically, mentally or legally complete financial transactions.

Thus, the illustrative communication system 200 facilitates and enables the mobile application 222: (i) to capture and track the customers financial actions via a system manager (SM) cloud based back end system. System manager 208 can perform overall system management, including but not limited to user management and financial action management. Interconnects with required authentication systems in order to authenticate the customer, log historical queries etc. Mobile application 222 can communicate with the simulacrum engine (SE) cloud based back end system. The simulacrum engine 216 can: (i) capture and track the customers financial actions; (ii) capture and track the customers social media posts; (iii) capture and track the customers email communications; (iv) capture and track the customers heath based information; (v) analyze and detect the patterns of financial behavior of the customer; (vi) using machine learning, among other methodologies, develop a simulacrum which can trigger similar activities when similar criteria occur; (vii) trigger financial actions as required, once the customer is unable to. The mobile application 222 can communicate with a simulacrum engine database (SED) of customer activity. The simulacrum engine database can store and manage customer activity. The APIs 248, 250, 252 can provide interconnectivity between banks, social networks, payment systems, health tracking services, communications tools and others

In an illustrative embodiment, a customer or caregiver wishes to leverage the system in order to create a financial continuity plan for the customer. The customer or caregiver agrees to be monitored/monitor in order to create the simulacrum. From this point on the system begins to track all of the activities, on all possible interfaces (mobile, web, chat, text), required in order to generate a simulacrum which can ensure financial continuity. These monitored activities can include, but are not limited to: (i) financial transactions of any type: bill payments, credit card charges, transfers, or checks; (ii) social transactions of any type (e.g., social media posts, messenger communications); (iii) communications of any type (e.g., email, text, chat); (iv) health information of any type (e.g., activity trackers, heart rate monitors etc.). The simulacrum engine then begins to build a rule set of triggers and transactions, based on machine learning and predictive analytics.

During steady state operation, the human operator can choose to perform financial transactions. The system monitors inputs over time in order to capture patterns of financial behavior. At this point, the system will not take on any of the transactions itself, but continue to monitor the customers financial actions. In one embodiment, the system could alert the customer if they have forgotten to complete an action, if they complete one or more of the following actions.

Operation of virtual transaction continuity can change in response to a customer-initiated trigger event. The customer indicates to the system that they wish to enable the simulacrum. After confirmation, the simulacrum will then continue to complete the financial actions of the customer as if the customer was completing the actions. Enablement can be limited to types of transactions, specific transactions, monetary ranges of transaction, etc. The simulacrum will operate until it is told to stop by the customer or by customer's assigned caregiver. The simulacrum can provide reporting on a regular basis (daily, weekly, monthly, on-demand) to the customer in a pre-selected medium, of the transactions which it is undertaking.

Operation of virtual transaction continuity can change due customer inactivity been deemed a triggering event. Consider that the customer is incapacitated in some way. The system expects the customer to complete specific financial actions. When those actions are not completed, the system assumes that the customer has been incapacitated in some way, and begins to complete the actions on the customer's behalf, informing any caregivers. At this point, the simulacrum then takes on the financial actions that the customer typically performs and completes them on behalf of the customer, at the date and time the customer typically completes them. In one or more embodiments, if the customer typically completes the action via a face-to-face meeting, the system can find a viable alternative method in order to communicate the change of channel to the other parties. This activity continues until the simulacrum is informed that it is no longer required to perform the actions, and returns to monitoring the customer, either via the customer or the customers proxy. The simulacrum can provide reporting on a regular basis (daily, weekly, monthly, on-demand) to the customer or their caregiver in a pre-selected medium, of the transactions which it is undertaking.

Operation of virtual financial continuity can detect that the customer is incapacitated. For example, the customer continues to perform financial transactions. The system monitors health and location inputs and can trigger the activation of the simulacrum, and well as any accompanying alerts to the customer as or caregivers, if there are any major changes to the customers incoming health data. This can continue until the health data and location inputs return to normal, or can be reverted by the customer or caregiver. The simulacrum can provide reporting on a regular basis (daily, weekly, monthly, on-demand) to the customer or their partner/caregiver in a pre-selected medium, of the transactions which it is undertaking.

Operation of virtual financial continuity can detect that the customer is deceased. For example, the simulacrum will automatically go into operation once it detects that the customer is incapacitated. If the customer then passes away, the system can automatically reconfigure payments and perform other actions in order to map tot the new situation. In the case of one customer with a surviving spouse, the system may automatically change plans and other payment structures in order to account for the change in status. For example, the surviving spouse may now qualify for a different health care plan, or a reduced wireless phone cost. The system, once informed of the death of the customer, can automatically trigger changes in order to optimize the financial health of the surviving spouse. Additionally, the system can begin to provide reporting of the financial transactions on a regular basis to the surviving spouse, in order for them to understand the transactions which were occurring.

In one or more embodiments, the system can be used by healthy individuals to offload their regular financial transaction burden, while allowing the customer to remain in full independent control of the transactions, as opposed to using a financial institutions autopay method. The customer can add their own specific rules in order to manage payments and detect abnormalities, triggering notifications. For example, the system may pay a wireless phone bill if the amount is $119 (the typical monthly amount), but triggers an alert if the amount is higher than $149.

The simulacrum, once it understands the customer's pattern of financial actions, can also suggest new patterns of behavior which will be more beneficial to the customer's financial well-being. The customer's pattern can be compared with other similar patterns of customers who are able to improve their financial health. The simulacra may be able to “compare notes” and provide advice to their customers on how to improve their financial health

Once the simulacrum has gleaned enough information in order to understand the customers typical financial patterns, they could conceivably assist in the undertaking of their action by providing advisory services to the customer, via a visual and/auditory avatar of the simulacrum, which can present itself to the customer as a possible virtual banker. This avatar can appear as an overlay in any financial application that the customer is using (web, mobile) and assist the customer in the completion of the financial tasks required.

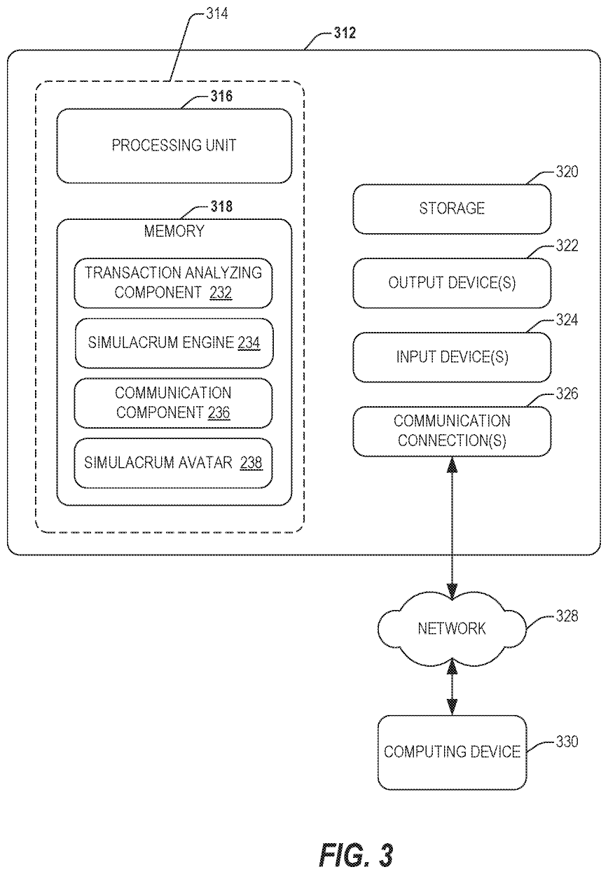

FIG. 3 and the following discussion provide a description of a suitable computing environment to implement embodiments of one or more of the provisions set forth herein. The operating environment of FIG. 3 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 3 illustrates a system 300 including a computing device 312 configured to implement one or more embodiments provided herein. In one configuration, computing device 312 includes at least one processing unit 316 and memory 318. Depending on the exact configuration and type of computing device, memory 318 may be volatile, such as RAM, non-volatile, such as ROM, flash memory, etc., or a combination of the two. This configuration is illustrated in FIG. 3 by dashed line 314.

In other embodiments, device 312 includes additional features or functionality. For example, device 312 may include additional storage such as removable storage or non-removable storage, including, but not limited to, magnetic storage, optical storage, etc. Such additional storage is illustrated in FIG. 3 by storage 320. In one or more embodiments, computer readable instructions to implement one or more embodiments provided herein are in storage 320. Storage 320 may store other computer readable instructions to implement an operating system, an application program, etc. Computer readable instructions may be loaded in memory 318 for execution by processing unit 316, for example.

The term “computer readable media” as used herein includes computer storage media. Computer storage media includes volatile and nonvolatile, removable and non-removable media implemented in any method or technology for storage of information such as computer readable instructions or other data. Memory 318 and storage 320 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by device 312. Any such computer storage media is part of device 312.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 312 includes input device(s) 324 such as keyboard, mouse, pen, voice input device, touch input device, infrared cameras, video input devices, or any other input device. Output device(s) 322 such as one or more displays, speakers, printers, or any other output device may be included with device 312. Input device(s) 324 and output device(s) 322 may be connected to device 312 via a wired connection, wireless connection, or any combination thereof. In one or more embodiments, an input device or an output device from another computing device may be used as input device(s) 324 or output device(s) 322 for computing device 312. Device 312 may include communication connection(s) 326 to facilitate communications via a network 228 with one or more other computing devices 230.

Certain functionalities of virtual financial continuity can be performed by software applications resident in memory 318, such as a transactional analyzing component 332, simulacrum engine 234, communications monitoring component 336, and a simulacrum avatar 238.

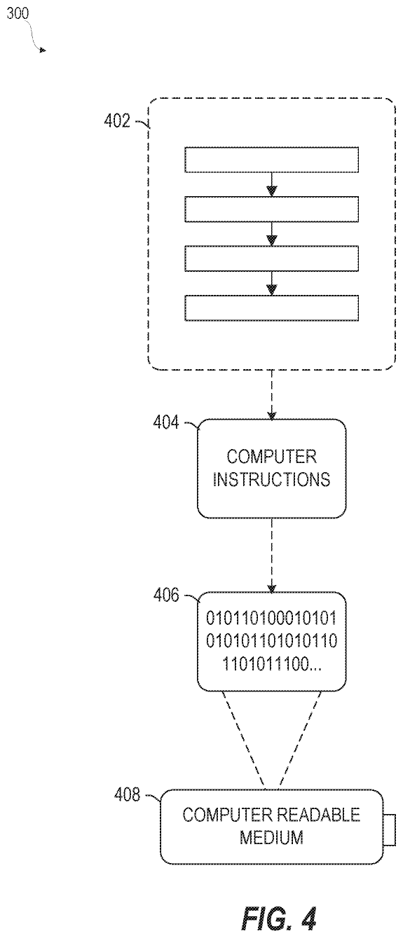

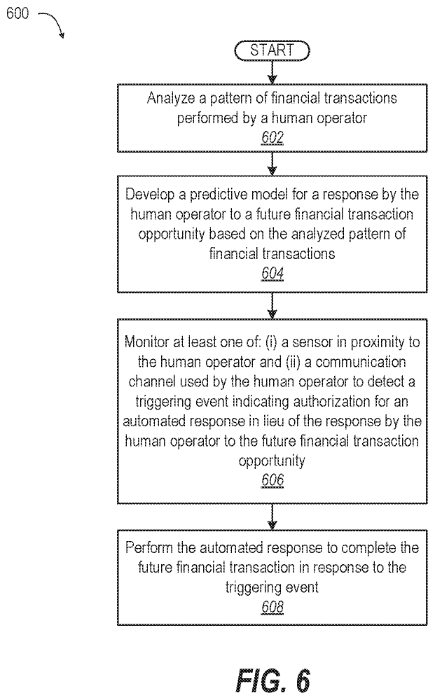

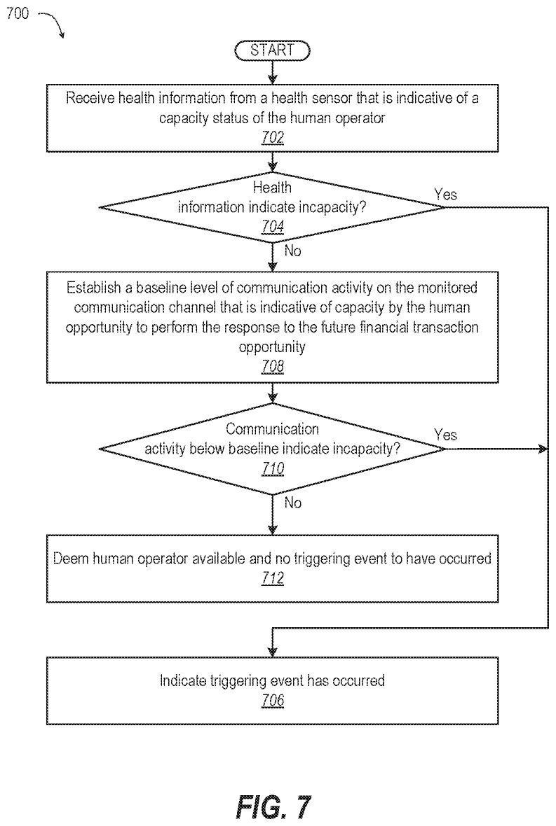

Still another embodiment involves a computer-readable medium including processor-executable instructions configured to implement one or more embodiments of the techniques presented herein. An embodiment of a computer-readable medium or a computer-readable device devised in these ways is illustrated in FIG. 4, wherein an implementation 400 includes a computer-readable medium 408, such as a CD-R, DVD-R, flash drive, a platter of a hard disk drive, etc., on which is encoded computer-readable data 406. This computer-readable data 406, such as binary data including a plurality of zero's and one's as shown in 406, in turn includes a set of computer instructions 404 configured to operate according to one or more of the principles set forth herein. In one such embodiment 400, the processor-executable computer instructions 304 may be configured to perform a method 402, such as method 600 of FIG. 6 or method 700 of FIG. 7. In another embodiment, the processor-executable instructions 404 may be configured to implement a system, such as the system 300 of FIG. 3. Many such computer-readable media may be devised by those of ordinary skill in the art that are configured to operate in accordance with the techniques presented herein.

In one or more embodiments, at least a portion of the system 300 (FIG. 3) can be implemented by a portable device 400 having a user interface 402 for interacting with a user.

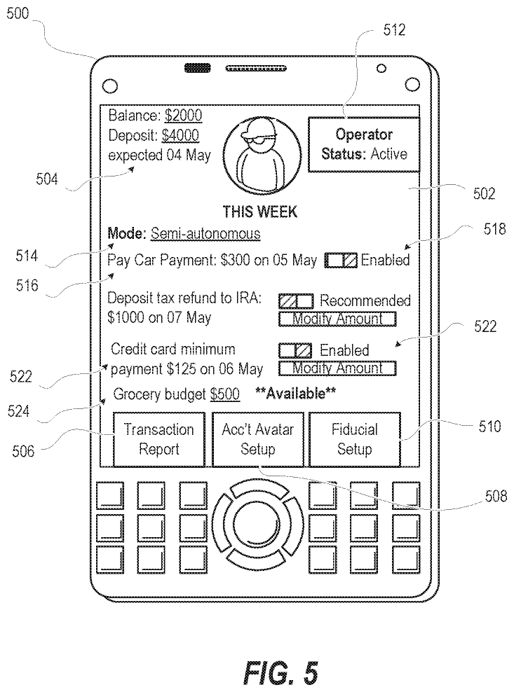

FIG. 5 illustrates a user device 500 having a user interface 502 that provides information and control functionality to a customer or human operator that benefits from virtual financial continuity. For example, the user interface 502 can report on a current financial situation such as current balance information 504. A transaction report control affordance 506 can pull up completed transactions. An account avatar setup control affordance 508 can allow configuring of authorizations for particular accounts or other pre-authorizations. A fiducial setup control affordance 510 can allow pre-configuring another individual or corporate entity to serve as a caretaker or guardian of financial transactions upon the voluntary relinquishment or automatic detection of incapacity of the human operator.

The user interface 502 can provide its current assessment 512 of the operator status, such as active, active but overdue in completing financial transactions, unavailable, temporarily incapacitated, permanently incapacitated, or deceased. The user interface 502 can indicate a current level of autonomy 514, such as disabled, monitoring financial transactions, semi-autonomously handling certain financial transactions, autonomously handling all financial transactions for the human operator, semi-autonomously handling certain financial transactions for the fiducial entity, or autonomously handling all financial transactions for the fiducial entity. The user interface 502 can provide reporting of currently authorized automatic financial transactions 516 for the upcoming reporting period, which can be modified by a transaction enablement control affordance 518. The user interface 502 provided recommended financial transactions 520 to prompt the user for individual authorization or modification by control affordances 522. The user interface 502 can also provide information about effects on manually transacted budgets, such as a grocery budget status 524.

FIG. 6 illustrates a method 600 for automating performance of a pattern of financial transactions, according to one or more embodiments. At 602, a pattern of financial transactions performed by a human operator are analyzed. At 604, a predictive model for a response by the human operator to a future financial transaction opportunity is developed based on the analyzed pattern of financial transactions. At 606, at least one of: (i) a sensor in proximity to the human operator and (ii) a communication channel used by the human operator is monitored to detect a triggering event. The trigger event indicates authorization for an automated response in lieu of the response by the human operator to the future financial transaction opportunity. At 608, the automated response is performed to complete the future financial transaction in response to the triggering event.

FIG. 7 illustrates a method 700 of determining a capacity of the human operator, according to one or more embodiments. At 702, health information is received from a health sensor that is indicative of a capacity status of the human operator. At 704, a determination is made as to whether the health information indicates an incapacity of the human operator to perform the response to the future financial transaction opportunity as the trigger event. In response to a determination of incapacity, the trigger event is indicated at 706. In response to no determination of incapacity, at 708 a baseline level of communication activity on the monitored communication channel is established that is indicative of capacity by the human opportunity to perform the response to the future financial transaction opportunity. For example, monitoring of the communication channel used by the human operator can include at least one of: (i) a social website; (ii) an email service; and (iii) a messaging service. At 710, a determination is made as to whether the human opportunity is incapacitated based upon detecting the communication activity being below the baseline level for a period of time. In response to the determination of incapacity, the trigger event is indicated at 706. In response to the no determination of incapacity, at 712 the human operator is deemed available and no triggering event has occurred.

In one or more embodiments, a method includes developing the predictive model by categorizing responses by the human operator to respective financial transaction opportunities into at two or more of the following categories: (i) recurring payment of a billed amount; (ii) a recurring partial debt payment correlated to a minimum payment amount; (iii) a recurring money transfer amount to a selected recipient; and (iv) a non-recurring financial transaction. Performing the automated response is contingent upon the financial transaction opportunity being a recurring event that is categorized in the predictive model.

In one or more embodiments, a method includes determining that the capacity of the human operator is a temporary unavailability. In response to determining that the human operator is temporarily unavailable, performing the automated response is in response to determining that the predictive model indicates that a response by the human operator is overdue.

In one or more embodiments, a method includes determining that the capacity of the human operator is temporary unavailability by monitoring a calendar function of a productivity system. The method includes detecting a travel schedule of the human operator that is posted in the calendar function.

In one or more embodiments, a method includes tracking one or more automated responses and reporting the tracked one or more automated responses to a user interface. In one or more particular embodiments, a method includes determining that the capacity of the human operator is permanently unavailable to perform the response. In response to determining that the human operator is permanently unavailable, the method includes accessing an assignment of a fiducial operator for the human operator. A recommendation for the automated response is reported to the fiducial operator.

In one or more embodiments, a method includes performing an interactive training period for developing the predict model. The method includes detecting the financial transaction opportunity based at least in part on one of: (i) receiving a billing prompt; and (ii) determining a due date for a recurring financial transaction. Based on currently analyzed financial transactions, the method includes presenting one or more recommendations as a respective control affordance on a user interface to the human operator for responding to the financial transaction operator. The method includes performing an automated response that is consistent with a received activation of a control affordance.

In one or more embodiments, a method includes detecting a financial transaction opportunity comprising receipt of a nonrecurring asset. The method includes determining a recommendation for transferal of the nonrecurring asset based on a prioritization indication contained in the predictive model.

In one or more embodiments, a method includes developing the predictive model by determining that the response by the human operator to financial transaction was performed by a human-to-human interaction. The method includes performing the automated response by accessing at least one machine-accessible contact address to the recipient of the future financial transaction opportunity. A machine-to-human analog is determined for the human-to-human interaction. The method includes performing the machine to human analog. For example, the machine-to-human analog can be one of: (i) an interactive voice recognition telephone communication; (ii) an email message; (iii) an electronic funds transfer; and (iv) an automated check printing and mailing service.

With the benefit of the foregoing disclosure, the present disclosure addresses long-felt needs. As customers age, in order to handle situations where customers may become incapacitated and unable to perform financial actions required, it is important to provide the ability for customers to maintain the set of financial actions. This is true for both medical incapacitation and for increasingly mobile and disconnected customer base that is looking for ways in which to automate mundane financial tasks.

Consider the follow illustrative use case. Mario and Janice are an elderly couple who live in their mortgage-free home and are enjoying their retirement. Mario does a lot of golfing and Janice takes care of all of the finances. During the recent meeting with their financial analyst, he suggested that they sign up for the virtual financial continuity service for Janice, just as insurance. They sign up for it, and it begins to monitors Janice's actions on the financial front. Over the course of time, it learns how she likes to pay bills, when to pay what and how to do it, and monitors all of her transactions. Out the blue, Janice is suddenly hospitalized for a mild stroke. The system detects that, and begins to take over for Janice, performing all of the normal financial actions on the days she typically does. It even calls the bank to initiate a transfer over the phone that she typically does in person, in order to allow her to get out of the house for a bit. After a few months of treatment and therapy, she goes back home, however with some small loss of abilities. The system recognizes this, and, in avatar form, asks if she would like any assistance in completing her regular financial transactions, which she accepts. The simulacrum now appears whenever she uses any app or website which is attached to her financial transactions.

The present disclosure thus provides: (i) an ability to map out current and potential future financial transactions by performing machine learning on the customers current financial patterns; (ii) an ability to step in and continue to complete transactions even if the customer is incapacitated; and (iii) an ability to revise the form of the transactions if the customer is deceased

One or more embodiments may employ various artificial intelligence (AI) based schemes for carrying out various aspects thereof. One or more aspects may be facilitated via an automatic classifier system or process. A classifier is a function that maps an input attribute vector, x=(x1, x2, x3, x4, xn), to a confidence that the input belongs to a class. In other words, f(x)=confidence (class). Such classification may employ a probabilistic or statistical-based analysis (e.g., factoring into the analysis utilities and costs) to prognose or infer an action that a user desires to be automatically performed.

A support vector machine (SVM) is an example of a classifier that may be employed. The SVM operates by finding a hypersurface in the space of possible inputs, which the hypersurface attempts to split the triggering criteria from the non-triggering events. Intuitively, this makes the classification correct for testing data that may be similar, but not necessarily identical to training data. Other directed and undirected model classification approaches (e.g., naive Bayes, Bayesian networks, decision trees, neural networks, fuzzy logic models, and probabilistic classification models) providing different patterns of independence may be employed. Classification as used herein, may be inclusive of statistical regression utilized to develop models of priority.

One or more embodiments may employ classifiers that are explicitly trained (e.g., via a generic training data) as well as classifiers which are implicitly trained (e.g., via observing user behavior, receiving extrinsic information). For example, SVMs may be configured via a learning or training phase within a classifier constructor and feature selection module. Thus, a classifier may be used to automatically learn and perform a number of functions, including but not limited to determining according to a predetermined criteria.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

1. A method for automating performance of a pattern of financial transactions, comprising:
determining a pattern of financial behavior performed by a human operator by analyzing financial transactions performed by the human operator, wherein the pattern indicates at least one triggering event and context around the at least one triggering event and wherein the pattern is not a periodic transaction;
developing a predictive model for a response by the human operator to a future financial transaction opportunity based on the analyzed pattern of financial transactions;
detecting a first contextual triggering event by a sensor in proximity to the human operator indicating authorization for an automated response in lieu of the response by the human operator to the future financial transaction opportunity, wherein the authorization is based on context determined by the sensor;
detecting a second contextual triggering event by a communication channel used by the human operator indicating authorization for the automated response in lieu of the response by the human operator to the future financial transaction opportunity, wherein the authorization is based on context determined from the communication channel; and
performing the automated response to complete the future financial transaction in response to detecting the first contextual triggering event and the second contextual triggering event, wherein performing the automated response includes a machine-to-human analog to complete the future financial transaction.

2. The method of claim 1, wherein:
wherein the sensor detects health information from a health sensor that is indicative of a capacity status of the human operator; and
detecting the first contextual triggering event comprises determining whether the health information indicates an incapacity of the human operator to perform the response to the future financial transaction opportunity.

3. The method of claim 1, wherein detecting on the communication channel used by the human operator comprises:
establishing a baseline level of communication activity that is indicative of capacity by the human operator to perform the response to the future financial transaction opportunity; and
determining whether the human operator is incapacitated based upon detecting the communication activity being below the baseline level for a period of time.

4. The method of claim 1, wherein the communication channel used by the human operator comprises monitoring at least one of: (i) a social website; (ii) an email service; and (iii) a messaging service.

5. The method of claim 1, wherein:
developing the predictive model comprises categorizing responses by the human operator to respective financial transaction opportunities into at least two or more of the following categories:
(i) recurring payment of a billed amount;
(ii) a recurring partial debt payment correlated to a minimum payment amount;
(iii) a recurring money transfer amount to a selected recipient; and
(iv) a non-recurring financial transaction; and
wherein performing the automated response is contingent upon the financial transaction opportunity being a recurring event that is categorized in the predictive model.

6. The method of claim 1, further comprising:
wherein detecting the second contextual triggering event includes determining that the capacity of the human operator is a temporary unavailability based on a calendar function; and
in response to determining that the human operator is temporarily unavailable, performing the automated response in response to determining that the predictive model indicates that a response by the human operator is overdue.

7. The method of claim 6, wherein determining that the capacity of the human operator is temporary unavailability comprises:
monitoring a calendar function of a productivity system; and
detecting a travel schedule of the human operator that is posted in the calendar function.

8. The method of claim 1, further comprising:
determining that the capacity of the human operator is permanently unavailable to perform the response; and
in response to determining that the human operator is permanently unavailable:
accessing an assignment of a fiducial operator for the human operator; and
reporting a recommendation for the automated response to the fiducial operator.

9. The method of claim 1, further comprising performing an interactive training period for developing the predict model by:
detecting the financial transaction opportunity based at least in part on one of:
(i) receiving a billing prompt; and
(ii) determining a due date for a recurring financial transaction;
based on currently analyzed financial transactions, presenting one or more recommendations as a respective control affordance on a user interface to the human operator for responding to the financial transaction operator; and
performing an automated response that is consistent with a received activation of a control affordance.

10. The method of claim 1, further comprising:
tracking one or more automated responses; and
reporting the tracked one or more automated responses to a user interface.

11. The method of claim 1, further comprising:
detecting a financial transaction opportunity comprising receipt of a nonrecurring asset; and
determining a recommendation for transferal of the nonrecurring asset based on a prioritization indication contained in the predictive model.

12. The method of claim 1, wherein the machine-to-human analog comprises:
developing the predictive model comprises determining that the response by the human operator to financial transaction was performed by a human-to-human interaction; and
performing the automated response comprises:
accessing at least one machine-accessible contact address to the recipient of the future financial transaction opportunity;
determining the machine-to-human analog for the human-to-human interaction; and
performing the machine-to-human analog.

13. The method of claim 12, wherein the machine-to-human analog comprises one of:
(i) an interactive voice recognition telephone communication;
(ii) an email message;
(iii) an electronic funds transfer; and
(iv) an automated check printing and mailing service.

14. A system comprising:
a transaction analyzing component that determines a pattern of financial behavior performed by a human operator by analyzing financial transactions performed by the human operator, wherein the pattern indicates at least one triggering event and context around the at least one triggering event and wherein the pattern is not a periodic transaction;
a simulacrum engine that develops a predictive model for a response by the human operator to a future financial transaction opportunity based on the analyzed pattern of financial transactions by the transaction analyzing component;
a communication component that detects: (i) a first contextual triggering event by a sensor in proximity to the human operator indicating authorization for an automated response in lieu of the response by the human operator to the future financial transaction opportunity, wherein the authorization is based on the context, wherein the triggering event is not customer-initiated and (ii) a second contextual triggering event by a communication channel used by the human operator indicating authorization for an automated response in lieu of the response by the human operator to the future financial transaction opportunity, wherein the authorization is based on the context, wherein the triggering event is not expressly initiated by a human; and
a simulacrum avatar that performs the automated response to complete the future financial transaction in response to the triggering event, wherein performing the automated response includes a machine-to-human analog to complete the future financial transaction.

15. The system of claim 14, wherein the communication component:
wherein the at least one sensor detects health information from a health sensor that is indicative of a capacity status of the human operator; and
detects the first contextual triggering event by determining whether the health information indicates an incapacity of the human operator to perform the response to the future financial transaction opportunity.

16. The system of claim 14, wherein the communication component monitors the communication channel used by the human operator by:
establishing a baseline level of communication activity that is indicative of capacity by the human operator to perform the response to the future financial transaction opportunity; and
determining whether the human operator is incapacitated based upon detecting the communication activity being below the baseline level for a period of time.

17. The system of claim 14, wherein:
the simulacrum engine develops the predictive model by categorizing responses by the human operator to respective financial transaction opportunities into at two or more of the following categories: (i) recurring payment of a billed amount; (ii) a recurring partial debt payment correlated to a minimum payment amount; (iii) a recurring money transfer amount to a selected recipient; and (iv) a non-recurring financial transaction; and
the simulacrum avatar performs the automated response contingent on the financial transaction opportunity being a recurring event that is categorized in the predictive model.

18. The system of claim 14, comprising:
a mobile application configured for determining whether the human operator is available, temporarily unavailable, or permanently unavailable;
in response to determining that the capacity of the human operator is temporary unavailable based on a calendar function, the simulacrum avatar performs the automated response in response to determining that the predictive model indicates that a response by the human operator is overdue; and
in response to determining that the capacity of the human operator is permanently unavailable, the simulacrum avatar:
accesses an assignment of a fiducial operator for the human operator; and
reports a recommendation for the automated response to the fiducial operator.

19. The system of claim 14, wherein the simulacrum engine performs an interactive training period for developing the predict model by:
detecting the financial transaction opportunity based at least in part on one of: (i) receiving a billing prompt; and (ii) determining a due date for a recurring financial transaction;
based on currently analyzed financial transactions, presenting one or more recommendations as a respective control affordance on a user interface to the human operator for responding to the financial transaction operator;
performing an automated response that is consistent with a received activation of a control affordance;
tracking one or more automated responses; and
reporting the tracked one or more automated responses to a user interface.

20. A non-transitory computer-readable storage medium comprising computer-executable instructions, which when executed via a processing unit on a computer performs acts, comprising:
determining a pattern of financial behavior performed by a human operator by analyzing financial transactions performed by the human operator, wherein the pattern indicates at least one triggering event and context around the at least one triggering event and wherein the pattern is not a periodic transaction;
developing a predictive model for a response by the human operator to a future financial transaction opportunity based on the analyzed pattern of financial transactions;
detecting a first contextual triggering event a sensor in proximity to the human operator indicating authorization for an automated response in lieu of the response by the human operator to the future financial transaction opportunity, wherein the authorization is based on the context;
detecting a second contextual triggering event a communication channel used by the human operator indicating authorization for an automated response in lieu of the response by the human operator to the future financial transaction opportunity, wherein the authorization is based on the context; and
performing the automated response to complete the future financial transaction in response to the triggering event, wherein performing the automated response includes a machine-to-human analog to complete the future financial transaction.
